(19) United States
(12) Patent Application Publication
(10) Pub. No.: US 2016/0305259 A1
(43) Pub. Date: Oct. 20, 2016

(54) TURBINE BLADE RETENTION CONFIGURATION

(71) Applicants: Charles Evans, Tequesta, FL (US); Andrew Narcus, Loxahatchee, FL (US); Paul DiCristoforo, Monson, MA (US); Karl Streb, Danielson, CT (US)

(72) Inventors: Charles Evans, Tequesta, FL (US); Andrew Narcus, Loxahatchee, FL (US); Paul DiCristoforo, Monson, MA (US); Karl Streb, Danielson, CT (US)

(21) Appl. No.: 15/096,466

(22) Filed: Apr. 12, 2016

Related U.S. Application Data
(60) Provisional application No. 62/146,719, filed on Apr. 13, 2015.

(51) Int. Cl. F01D 5/30; F01D 5/12; F04D 29/32; F01D 5/02

(52) U.S. Cl. CPC F01D 5/3007; F01D 5/02; F01D 5/12; F04D 29/322; F04D 29/324; F05D 2240/24; F05D 2260/30; F05D 2220/32

(57) ABSTRACT

A blade retention arrangement is disclosed for retaining a blade within a disk or wheel within a turbine. The blade retention arrangement includes a dovetail connected with the blade for insertion within a dovetail slot formed in a circumference of the disk or wheel. A first chamfer is formed on an axially front bottom edge of the dovetail and a first deformation of a axially front surface of the wheel presses against the first chamfer whereby a first radially outward force is exerted on the dovetail with respect to an axis of the wheel that presses the dovetail against a first centrifugal retention surface of the dovetail slot. A second chamfer may be formed on an axially back bottom edge of the dovetail that performs in the same manner. The first and second chambers may be formed on respective ones of a forward and aft spacer, or on a bottom spacer instead of being formed on the blade dovetail directly.

### FIELD OF THE INVENTION

This invention relates to the retention of aerodynamic blades around the circumference of a turbomachine disk, and particularly to the retention of blade root or dovetails in respective dovetail slots around the circumference of a rotating disk of a turbine or axial compressor.

### BACKGROUND OF THE INVENTION

Axial compressors and the hot gas path of turbines or turbomachines have one or more rotating disks or wheels, each holding a circular array of aerodynamic blades that extend radially from the disk or wheel circumference. The blades may be mounted in respective dovetail slots in the disk or wheel circumference in a conventional retention configuration as shown in FIG. 1. Clearance in the slot may be eliminated by deforming portions 32 of the disk or wheel to create an interference fit with the blade root. This deformation is called “staking”. Operational vibrations can wear the displaced material 38, loosening the fit and reducing blade stability.

### BRIEF DESCRIPTION OF THE DRAWINGS

The invention is explained in the following description in view of the drawings that show:

FIG. 1 is a front view of a blade mounted in a dovetail slot in a turbomachine disk or wheel.

FIG. 2 is a perspective view of a blade, platform, and root with spacers in a second conventional retention configuration.

FIG. 3 is a front view of a blade with a root with partly chamfered front and back ends showing aspects of embodiments of the invention.

FIG. 4 is a front view of a blade as in FIG. 3 mounted in a dovetail slot.

FIG. 5 is a perspective view of a blade as in FIG. 2 mounted in a dovetail slot with spacers in accordance with aspects of the invention.

FIG. 6 is a front view of a blade root with a bottom spacer mounted in a dovetail slot.

FIG. 7 is a bottom perspective view of a root bottom spacer with end chamfers.

FIG. 8 is a front view of a turbomachine disk or wheel holding a circular array of blades in a retention arrangement showing aspects of an embodiment of the invention.

### DETAILED DESCRIPTION OF THE INVENTION

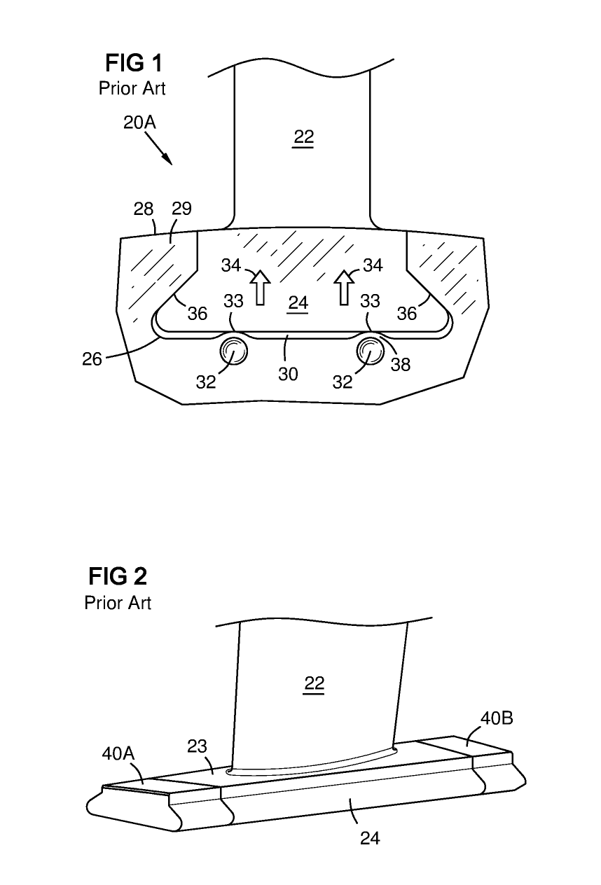

FIG. 1 shows a blade retention configuration 20A in which a blade 22 has a dovetail root 24 that is slidably mounted in a dovetail slot 26 in the circumference 28 of a turbomachine disk or wheel 29. As is known in the art, dovetail slot 26 extends between a forward and aft position on disk or wheel 29. Clearance 30 in the slot 26 is eliminated by mechanically deforming portions 32 of the disk to create an interference fit 33 that presses the blade root 24 radially outwardly 34 with respect to the disk axis, which presses the blade root against centrifugal retention surfaces 36 of the slot 26. The deformation process is called “staking”. Operational vibrations can cause wear in the material 38 displaced by staking, thus reducing blade stability. In exemplary embodiments of the invention, blade 22 may be one or more compressor blades mounted within respective slots of one or more compressor wheels 29 used within an industrial gas turbine, for example. Embodiments of the invention may be utilized in alternate turbines and are not limited to compressor blade and wheel combinations.

FIG. 2 is a perspective view of a blade 22, platform 23, and root 24. Spacers 40A, 40B may bracket the respective front (forward) and back (aft) ends of the root 24 in the slot 26 of FIG. 1 to retain the root axially in the slot. Staking 32 as in FIG. 1 may be used on the disk 29 adjacent such spacers.

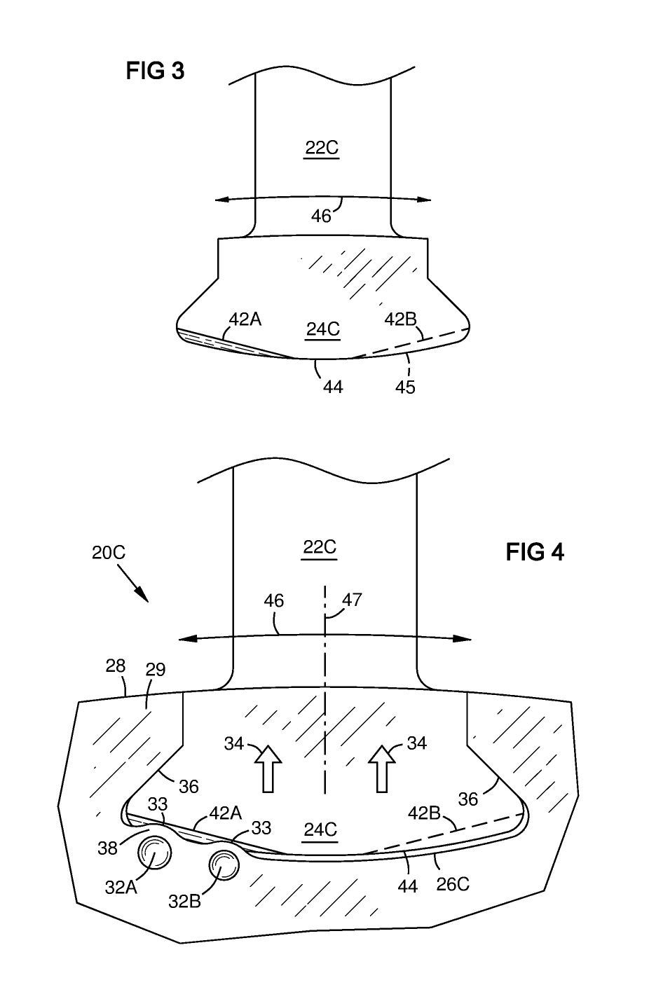

FIG. 3 is a front view of a blade 22C and root 24C showing aspects of embodiments of the invention. The root has a chamfer 42A, which may be offset circumferentially 46. For example, the chamfer 42A may cover only a left or right portion of the front bottom edge 44 the root. Alternately, the chamfer may cover the whole front bottom edge 44 of the root. A second chamfer 42B may cover part or all of the back bottom edge 45 of the root. The first and second chamfers 42A, 42B may be offset circumferentially to opposite sides of the root as shown. For example, the front chamfer 42A may be limited to the left half of the root, and the back chamfer 42B may be limited to the right half of the root as shown, or vice versa. Alternately, the two chamfers may be circumferentially offset to the same side (not shown).

FIG. 4 is a front view of a blade 22C with a partly chamfered root 24C as in FIG. 3 mounted in a dovetail slot 26C in a turbomachine disk 29 in a retention configuration 20C. Staking depressions 32A, 32B may be limited to only a circumferentially 46 left or right side of the root as shown. The chamfers 42A, 42B create a ramp effect providing a mechanical advantage that increases the radially outward 34 force on the root caused by the distorted portions 38. The chamfers also block sliding of the root axially (in a direction of the disk axis).

The surface of a chamfer 42A, 42B may be non-circumferential, meaning it is non-parallel to the disk circumference 28 as shown. For example, it may be at least 10 degrees or at least 15 degrees away from perpendicular to a radial line 47 through a center of the root 24C. Such an angled surface blocks the shifting of the root circumferentially 46 leftward for 42A and rightward for 42B. The bottom of the slot 26C may be concave and the bottom of the root 24C may be convex as shown. The chamfers 42A, 42B may be planar as shown, or in alternate embodiments of the invention they may follow the curvature of the root.

The chamfers 42A, 42B may be approximately 45-degree chamfers relative to the bottom and end surfaces of the root 24C. Alternately, each chamfer 42A, 42B may form an angle of about 30 degrees relative to the bottom of the root 24C in an axial direction, or it may form an angle of between about 25-35 degrees in some embodiments. Such an angle increases the mechanical advantage of the deformation on the root 24C in the radial 34 force direction when the deformed portion impinges on the surface of chamfer 42A, 42B.

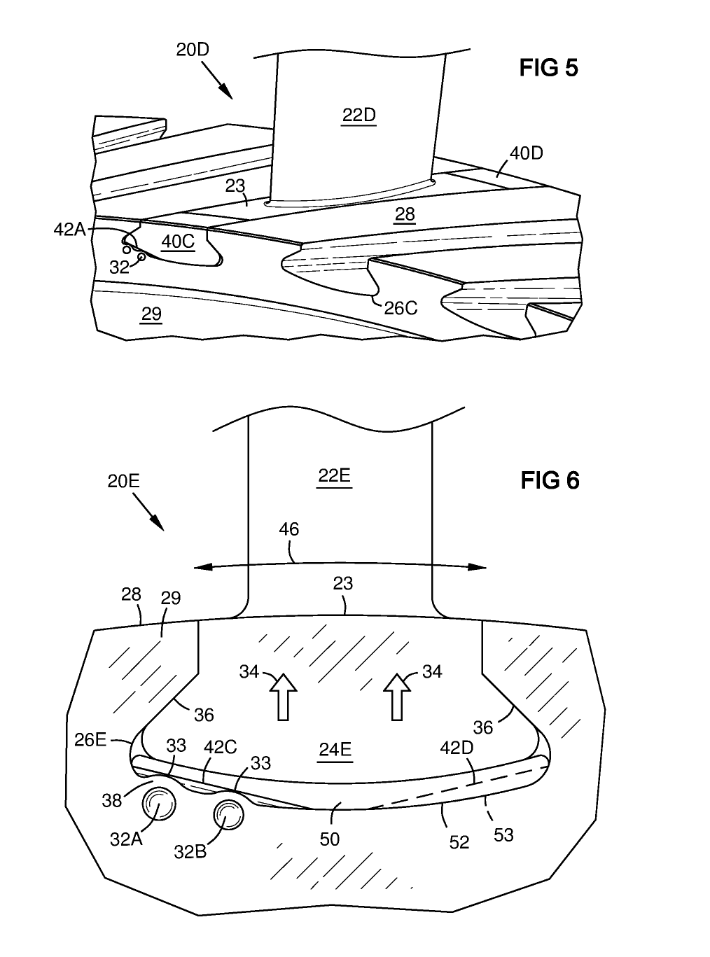

FIG. 5 is a perspective view of a blade 22D on a platform 23 with a root (not visible) mounted in a dovetail slot 26C in the circumference 28 of a disk 29. Spacers 40C, 40D bracket the front and back ends of the platform and the root in the slot 26C. An offset chamfer 42A may be provided on the front spacer 40C. A second offset chamfer 42B may be provided on the back spacer 40D as previously described for the back end 45 of the root 24C in FIG. 3. Together the root and spacers form a root apparatus or root arrangement that is mounted in the dovetail slot 26C in a retention arrangement 20D.

FIG. 6 is a front view of a blade 22E with a platform 23, a root 24E, and a bottom spacer 50 under the root 24E that acts as a shim between the root 24E and the slot 26E. Together the root 24E and spacer 50 form a root apparatus or root arrangement that is mounted in the dovetail slot 26E in a turbomachine disk 29 via a retention configuration 20E. Staking depressions 32A, 32B may be limited to only a left or right side of the root bottom spacer 50 as shown. The spacer 50 may have a bottom front edge 52 with a first chamfer 42C. The chamfer may be circumferentially offset as shown. The bottom of the spacer 50 may be convex as shown. A second chamfer 42D may be provided in the bottom back edge 53 of the spacer 50. The first and second chamfers may be offset in opposite circumferential directions. For example, the first chamfer 42C may be limited to the left half of the spacer 50 and the second chamfer 42D may be limited to the right half of the spacer 50. Alternately, not shown, the chamfers may cover most or all of the respective edges 52, 53.

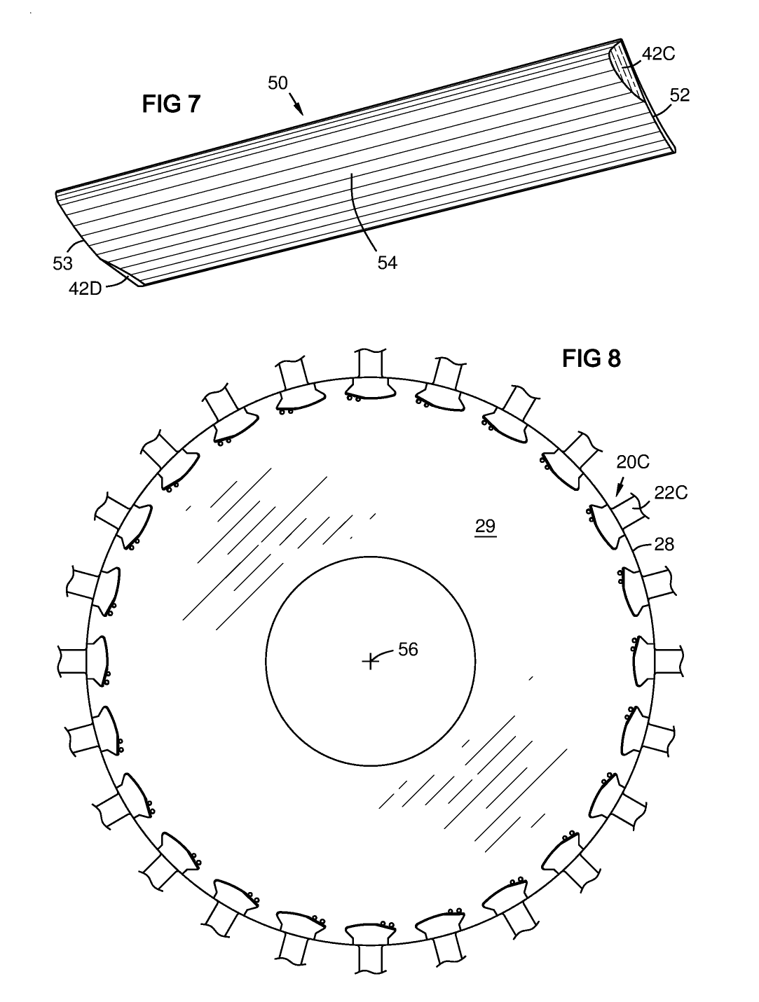

FIG. 7 is a bottom perspective view of exemplary geometry of a root bottom spacer 50 as in FIG. 6, with a first chamfer 42C in the front bottom edge 52, a second chamfer 42D in the back bottom edge 53, and a convex bottom surface 54. Similar chamfer and bottom surface geometry may apply to an embodiment of the blade root as in FIG. 3 when a spacer is not used.

FIG. 8 is a front view of a turbomachine disk 29 with an axis 56 and a circular array of blades 22C mounted in retention arrangements 20C as in FIG. 4.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A blade retention arrangement for a turbine, comprising:
a dovetail connected with the blade for insertion within a dovetail slot formed in a circumference of a wheel for use in the turbine;
a first chamfer formed on an axially front bottom edge of the dovetail; and
a first deformation of a axially front surface of the wheel that presses against the first chamfer whereby a first radially outward force is exerted on the dovetail with respect to an axis of the wheel that presses the dovetail against a first centrifugal retention surface of the dovetail slot.

2. The blade retention arrangement of claim 1, further comprising:
a second chamfer on an axially back bottom edge of the dovetail; and
a second deformation of an axially back surface of the wheel that presses against the second chamfer whereby a second radially outward force is exerted on the dovetail with respect to the axis of the wheel that presses the dovetail against a second centrifugal retention surface of the dovetail slot.

3. The blade retention arrangement of claim 2, wherein the first chamfer is limited to a circumferentially first half the dovetail and the second chamfer is limited to a circumferentially opposite half of the dovetail from the first chamfer.

4. The blade retention arrangement of claim 3, wherein the first chamfer is disposed on an axially front bottom edge of the dovetail and the second chamfer is disposed on an axially back bottom edge of the dovetail.

5. The blade retention arrangement of claim 3, wherein at least one of the first chamfer and the second chamfer forms an angle of between about 25 to 35 degrees relative to a bottom of the dovetail in an axial direction.

6. The blade retention arrangement of claim 5, wherein the at least one of the first chamfer and the second chamfer forms an angle of approximately 35 degrees relative to the bottom of the dovetail in an axial direction.

7. The blade retention arrangement of claim 5, a surface of the at least one of the first chamfer and the second chamfer is at least approximately 15 degrees away from perpendicular to a radial line through a center of the dovetail.

8. An apparatus for retaining a compressor blade dovetail within a dovetail slot of a compressor wheel for use in a turbine, the apparatus comprising:
a forward spacer sized to be inserted within the dovetail slot forward of the compressor blade dovetail;
an aft spacer sized to be inserted within the dovetail slot aft of the compressor blade dovetail; and
a chamfer formed on at least one of the forward spacer and the aft spacer, the chamfer having a surface formed at an angle so that a deformed portion of the compressor wheel abuts the surface.

9. The apparatus of claim 8, further comprising:
a first chamfer formed on the forward spacer; and
a second chamfer formed on the second spacer.

10. The apparatus of claim 9, further comprising:
the first chamfer formed on an axially forward bottom edge of the forward spacer; and
the second chamfer formed on an axially aft bottom edge of the aft spacer.

11. A blade retention apparatus for a turbomachine, comprising:
a root apparatus comprising a root of the blade, wherein the root apparatus is inserted into a slot in a circumference of a disk of the turbomachine;
a first chamfer on an axially front bottom edge of the root apparatus; and
a first deformation of a front surface of the disk that presses against the first chamfer, exerting a radially outward force on the root apparatus with respect to an axis of the disk that presses the root against a centrifugal retention surface of the slot.

12. The blade retention apparatus of claim 11, wherein the first chamfer is offset circumferentially to a first side of the root apparatus, and further comprising:
a second chamfer on an axially back bottom edge of the root apparatus, wherein the second chamfer is offset circumferentially to a second opposite side of the root apparatus from the first chamfer;
a second deformation of an axially back surface of the disk that presses against the second chamfer; and
wherein the second deformation exerts a second radially outward force on the root apparatus.

13. The blade retention apparatus of claim 12, wherein the first chamfer is limited to a circumferentially first half the root apparatus, and the second chamfer is limited to a circumferentially opposite half of the root apparatus from the first chamfer.

14. The blade retention apparatus of claim 13, wherein the chamfers are disposed on axially front and back bottom edges of the blade root.

15. The blade retention apparatus of claim 13, the root apparatus further comprising first and second spacers bracketing respective front and back ends of the blade root in the slot, wherein the first chamfer is disposed on a front bottom edge of the first spacer, and the second chamfer is disposed on a back bottom edge of the second spacer.

16. The blade retention apparatus of claim 13, wherein the root apparatus further comprises a spacer inserted between the blade root and a bottom of the slot, wherein the chamfers are disposed on the front and back bottom edges of the spacer.
